(19) United States
(12) Patent Application Publication
(10) Pub. No.: US 2010/0175633 A1
(43) Pub. Date: Jul. 15, 2010

(54) PET CARRIER

(75) Inventors: Julie Krauss, Totowa, NJ (US); Mai Shenghao, Shanghai (CN)

Correspondence Address: OSTROLENK FABER GERB & SOFFEN, 1180 AVENUE OF THE AMERICAS, NEW YORK, NY, 100368403, US

(73) Assignee: Allure Pet Products LLC, Totowa, NJ (US)

(21) Appl. No.: 12/686,079

(22) Filed: Jan. 12, 2010

Related U.S. Application Data
(60) Provisional application No. 61/143,866, filed on Jan. 12, 2009.

(51) Int. Cl. A01K 1/00

(52) U.S. Cl. 119/497

(57) ABSTRACT

A pet carrier having a pair of flexible side panels with mesh windows and an intermediate portion secured to the flexible side panels. The intermediate portion includes a relatively rigid bottom panel, a front panel, a top panel, a rear panel, and a main flap extending along the top panel and the front panel. The main flap is detachably secured to the top panel and the front panel to allow access to the interior of the pet carrier.

### CROSS REFERENCE TO RELATED APPLICATION(S)

The present application claims priority of U.S. Provisional application Ser. No. 61/143,866, filed Jan. 12, 2009, by Julie Krauss entitled PET CARRIER, the disclosure of which has been incorporated by reference.

### FIELD OF THE INVENTION

This invention relates generally to pet carrying devices.

### DESCRIPTION OF RELATED ART

There are many soft side carriers available in the pet industry today. However they contain many drawbacks making travelling with pets inconvenient. Many of the carriers are made of a material which cannot withstand the rigors of daily wear and traveling with pets. Additionally, support systems available within typical bags do not provide a proper rigidity to give pets a structure they need to be safe within a carrier. Another feature of many bags is a foam lining which some dogs and cats can scratch off to make the carrier messy and less effective as a carrier.

Further, most carriers do not include a bolster bed inside the carrier so that the carrier can be converted to a bed. Most pet owners may consider bringing a separate bed for the pet while traveling. Many of the currently available carriers contain no pet identification tag or include one that can easily be lost. The carriers today force consumers to choose between a convenient yet heavy and non-collapsible carrier and one that is collapsible but must be carried on a user's shoulder. Finally, many of the carriers today rely on a wooden board for the bottom support. Many times when a pet urinates in the carrier such bottom will warp and render the carrier useless.

An example of a conventional pet carrier is described in U.S. Pat. No. 7,392,764, incorporated herein by reference. The '764 patent discloses a carrier having a generally rectangular case with one side being hingedly connected to allow it to open. Another side of the rectangular case includes an opening allowing the animal to extend its head and neck therethrough. While the carrier shown in the '764 patent provides adequate structural support for the animal, it is heavy, non-collapsible and generally hard to carry around.

### SUMMARY OF THE INVENTION

It is an object of the invention to provide a pet carrier having a pair of flexible side panels with mesh windows and an intermediate portion secured to the flexible side panels. The intermediate portion includes a relatively rigid bottom panel, a front panel, a top panel, a rear panel, and a main flap extending along the top panel and the front panel. The main flap is detachably secured to the top panel and the front panel to allow access to the interior of the pet carrier.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a front perspective view of the pet carrier in accordance with the preferred embodiment of the invention.

FIG. 2 is a rear perspective view of the pet carrier in accordance with the preferred embodiment of the invention.

FIG. 3 is a perspective view of the pet bed insertable into the pet carrier in accordance with the preferred embodiment of the invention.

FIG. 4 is a view of the pet carrier with an open rear flap showing an internal arrangement of the pet carrier in accordance with the preferred embodiment of the invention.

### DETAILED DESCRIPTION OF THE PREFERRED EMBODIMENT AND THE DRAWINGS

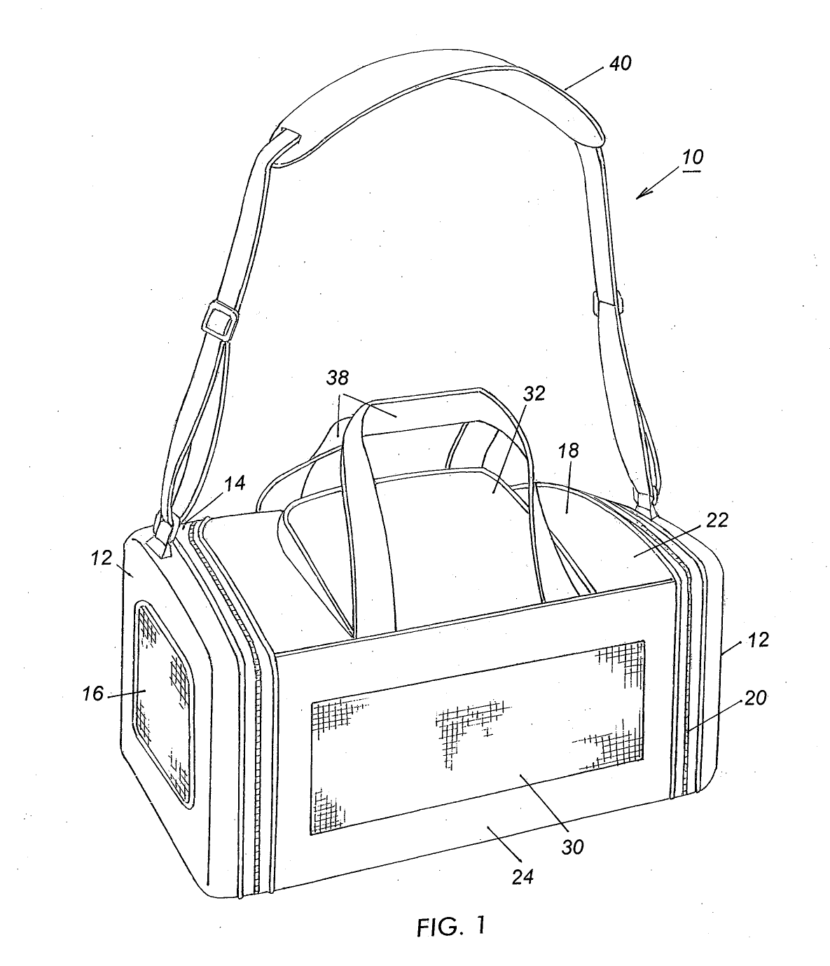

In the preferred embodiment shown, for example in FIG. 1, the pet carrier 10 is a box-like structure having two soft side panels 12 and an intermediate portion 14. Side panels 12 are preferably EVA-molded to provide adequate structural support for the carrier while giving the carrier enough flexibility to conform to fit under an aircraft chair, for example. Each side panel 12 includes a resin mesh window 16 to allow air into the carrier and to provide its user with a view of the pet inside the carrier.

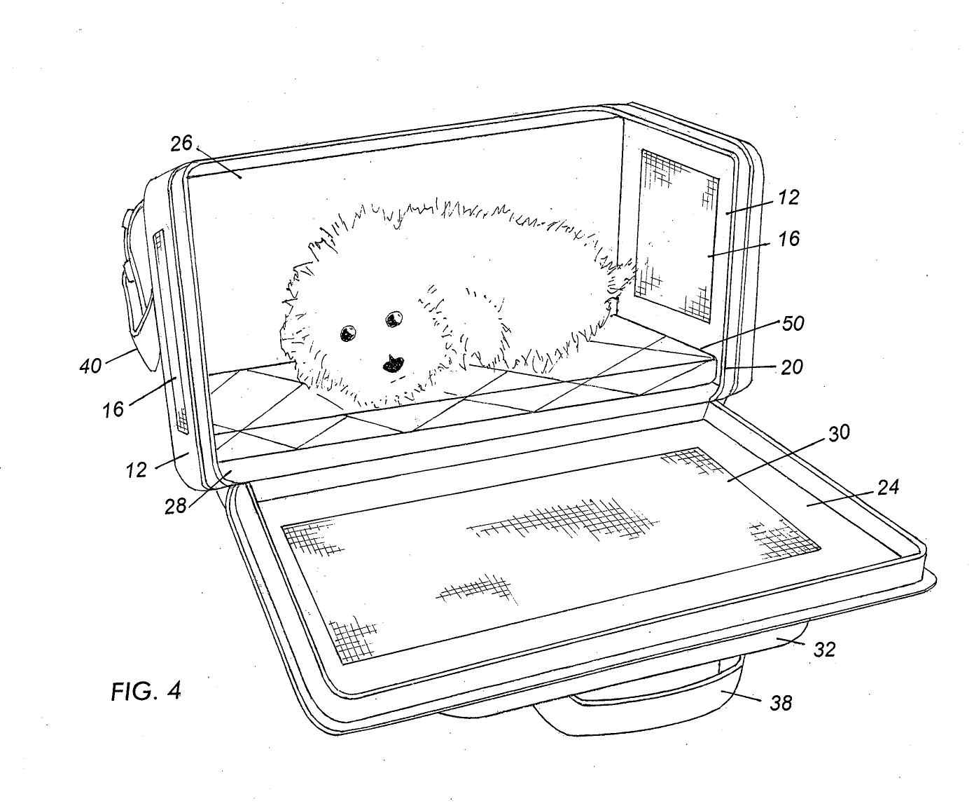

Intermediate portion 14 preferably includes a top panel 22, a front panel 24, a rear panel 26 and a bottom panel 28. Intermediate portion 14 further includes a main flap 18 secured to the remainder of the intermediate portion 14 by a self-lock zipper 20. Any other suitable form of flap attachment may be utilized with the invention. As shown in FIG. 4, the main flap 18 extends from the top panel 22 of the intermediate portion 14 all the way down the front panel 24 such that when the main flap is open, there is a wide and easy access to the pet inside the carrier. Further, the main flap is preferably permanently attached to the bottom panel 28 such that, in its open state, the main flap 18 constitutes extension of the bottom panel 28. For additional ventilation, main flap 18 includes a large front resin mesh window 30 located in a position corresponding substantially to the entire front panel 24, as shown in FIG. 1. Accordingly, excellent ventilation of the pet carrier is achieved by the front mesh window 30 and two side mesh windows 16.

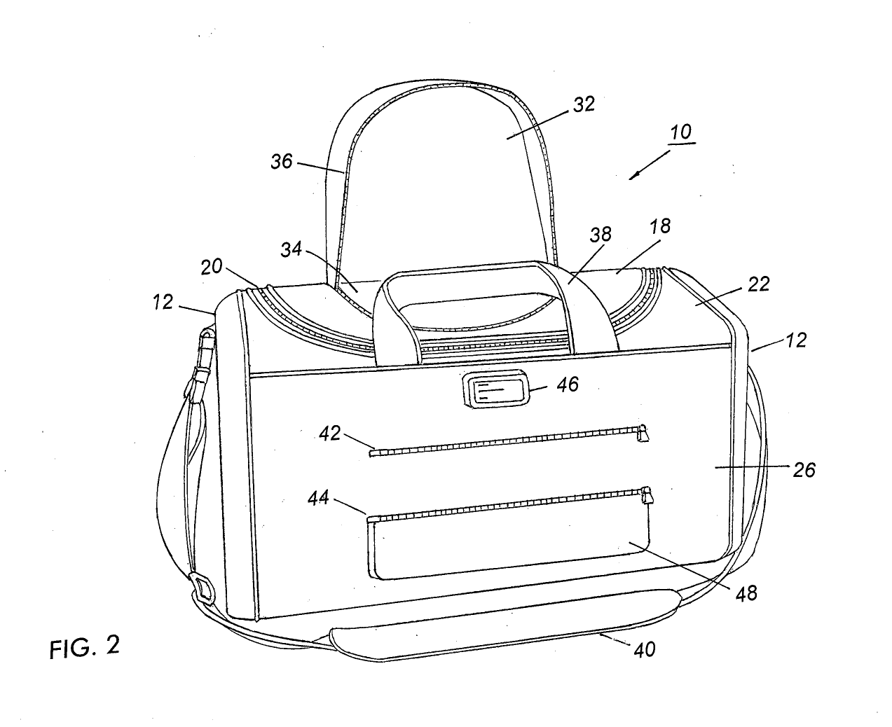

As shown in FIGS. 1-2, the main flap 18 is further provided with a top compartment 32 located in a position corresponding to the top panel 22. Top compartment 32 is preferably provided to store pet accessories. Easy access to the top compartment is enabled by a large top flap 34 secured to the surface of the main flap 18 by a zipper 36.

Additionally, as shown in FIG. 2, a rear compartment 48 is preferably sewn onto the surface of the rear panel 26. Access to the rear compartment is enabled by a zipper 44. The pet carrier also includes an ID tag 46 securely attached to the rear panel 26 for a pet owner to record pet's and owner's information. Although the tag 46 is shown to be attached to the rear panel, it should be understood that it can be attached to any panel of the pet carrier.

The bottom panel 28 is preferably more rigid than other panels of the carrier. For additional structural stability, a PE board (not shown) is inserted into the bottom panel 28.

The carrier is further provided with a pair of padded carrying handles 38 and a three-layer comfort shoulder strap 40. A separate telescope wheel accessory (not shown) may be attached to the pet carrier by, for example, a hook-and-loop attachment to convert the carrier into a wheeled module. The pet carrier can also be placed onto a wheeled luggage and secured to such luggage by a zipper-adjustable back strap 42 attached to the rear panel 26.

In addition to the self-lock zipper 20 at the opening of the main flap 18, to enable security and to prevent pet escape, the pet carrier includes a leash attachment mechanism (not shown) provided inside the carrier. The pet carrier is preferably constructed of 1680D Polyester Oxford fabric with EVA molded to the fabric to give the carrier a smooth outside finish and also to eliminate messy inside foam often found in carriers that pets can chew, claw and destroy. The inside lining is preferably 100% polyester 190T Taffeta.

In the preferred embodiment, the pet carrier is manufactured in two sizes: medium, i.e., 20″×11″×10.5″; and large, i.e., 22″×12″×11.5″; with corresponding internal spaces of 18″×10″×10″ and 20″×11″×11″.

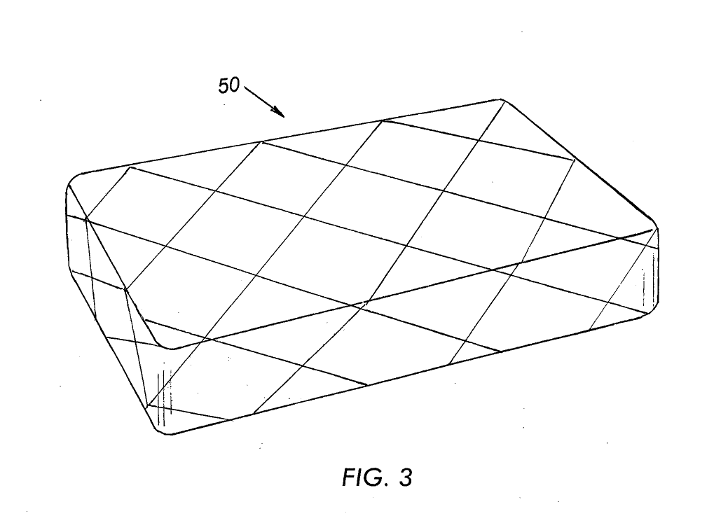

Finally, as shown in FIG. 3, the pet carrier includes a removable bed 50. The bed preferably includes a quilted cushion with comfortable poly batting and a long bolster stuffed with poly fill for pet to rest its head on. A cover of the removable bed is preferably made of washable and removable flocking so it is easy to clean and replace.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

What is claimed is:

1. A pet carrier comprising:
a pair of flexible side panels;
an intermediate portion secured to the flexible side panels, the intermediate portion including a relatively rigid bottom panel, a front panel, a top panel, a rear panel, and a main flap extending along the top panel and the front panel and being detachably secured to the top panel and the front panel, the main flap being openable to allow access to an interior of the pet carrier.

2. The pet carrier according to claim 1, wherein each of the flexible side panels includes a side mesh window.

3. The pet carrier according to claim 1, wherein the main flap comprises a front mesh window.

4. The pet carrier according to claim 1, further comprising a top compartment secured to the main flap.

5. The pet carrier according to claim 1, further comprising a pet bed removable from the pet carrier.

6. The pet carrier according to claim 1, further comprising at least one carrying handle.

7. The pet carrier according to claim 1, wherein the rear panel comprises a rear compartment.

8. The pet carrier according to claim 1, further comprising an ID tag secured to one of the panels of the pet carrier.

9. The pet carrier according to claim 1, further comprising an adjustable strap secured to the rear panel of the pet carrier, the adjustable strap being operable to secure the pet carrier to a luggage case.

10. The pet carrier according to claim 1, wherein the panels of the pet carrier are made of polyester fabric and ethylene vinyl acetate molded to the fabric.
